(19) United States
(12) Patent Application Publication
(10) Pub. No.: US 2013/0341255 A1
(43) Pub. Date: Dec. 26, 2013

(54) Multiple Core Spiral Separator and Method Therefor

(71) Applicants: Steve Eugene DeJong, Maple Grove, MN (US); Dorris DeJong, Maple Grove, MN (US); Chad Culbertson, Zimmerman, MN (US)

(72) Inventors: Steve Eugene DeJong, Maple Grove, MN (US); Dorris DeJong, Maple Grove, MN (US); Chad Culbertson, Zimmerman, MN (US)

(21) Appl. No.: 13/528,583

(22) Filed: Jun. 20, 2012

(51) Int. Cl. B07B 7/083

(52) U.S. Cl. 209/606

(57) ABSTRACT

A spiral separator apparatus is used to separate a mixture of particles of different shapes. The spiral separator apparatus includes rotating separator cores that each have a number of banked flights. As the separator cores rotate, non-round particles continue traveling down the banked flights, while round or substantially round particles are ejected from the separator core by centrifugal force. Particles that are ejected from the separator cores impact a housing, fall, and are collected, for example, in a collection bin.

### TECHNICAL FIELD

This disclosure relates generally to industrial and agricultural machinery. More particularly, the disclosure relates to spiral separators.

### BACKGROUND

Spiral separators are used to sort particulate material, such as seeds, metal shot, and glass or ceramic media from other media in which they are present. A spiral separator generally includes a number of flights that are spirally wound around a central axis. Some particles, such as seeds or shot that are spherical or substantially spherical, travel faster than other particles and are flung off the flights and are collected in a receptacle, such as a bin. Non-round particles travel more slowly and are not flung off the flights, but are instead collected at the bottom of the spiral separator.

Some conventional spiral separators are adversely affected by certain drawbacks. For instance, because the rate of incline in the spiral flights and the banking angle of the flights are generally predetermined by the manufacturer, some conventional spiral separators are relatively inflexible in adjusting the separation of material for roundness and yield. They also lack adjustability for separating the same type of material when the material size and weight may be different between different batches.

### SUMMARY OF THE DISCLOSURE

According to various example embodiments, a spiral separator apparatus is used to separate a mixture of particles of different shapes. The spiral separator apparatus includes rotating separator cores that each have a number of banked flights. As the separator cores rotate, non-round particles continue traveling down the banked flights, while round or substantially round particles are ejected from the separator core by centrifugal force. Particles that are ejected from the separator cores impact a housing, fall, and are collected, for example, in a collection bin.

One embodiment is directed to a spiral separator apparatus that has a motor and a plurality of hollow shafts coupled to the motor. To each hollow shaft is coupled a separator core. The separator cores are arranged to rotate when the motor is energized. Each separator core has a plurality of banked flights spirally disposed around an axis coincident with an axis of the respective hollow shaft. A feed portion is proximate respective top end portions of the separator cores and is arranged to receive a mixture of substantially round particles and non-round particles and to distribute the mixture substantially evenly among the separator cores. A housing substantially surrounds the separator cores and is arranged to be impacted by substantially round particles cast from the separator cores when the separator cores rotate.

Another embodiment is directed to a spiral separator apparatus comprising a motor and a control module configured to control a rotational speed of the motor. The spiral separator apparatus also includes a plurality of hollow shafts and a belt drive coupled between the motor and the hollow shafts and arranged to rotate the hollow shafts when the motor is energized. The spiral separator apparatus also includes a plurality of separator cores. Each separator core is coupled to a respective hollow shaft and arranged to rotate when the respective hollow shaft rotates. Each separator core has a plurality of banked flights spirally disposed around an axis coincident with an axis of the respective hollow shaft. A feed portion is proximate a top end portion of the separator core and is arranged to receive a mixture of substantially round particles and non-round particles and to distribute the mixture substantially evenly among the plurality of separator cores.

Still another embodiment is directed to a method of separating a plurality of substantially round particles from a mixture of the substantially round particles and a plurality of non-round particles. A motor is energized to cause a plurality of separator cores of a spiral separator apparatus to rotate about respective axes. Each separator core has a plurality of banked flights spirally disposed around a respective hollow shaft. The mixture of substantially round particles and non-round particles is passed through a feed portion of the separator apparatus and is distributed among the separator cores. The substantially round particles are ejected from the banked flights of the separator cores and impact a housing substantially surrounding the separator cores when the separator cores rotate. The substantially round particles are collected after they impact the housing.

The disclosed embodiments may realize certain advantages. For instance, the use of multiple rotating separator cores can realize faster, more efficient sorting than a single separator core. In addition, the housing may prevent substantial ingress or egress of contaminants and leakage of round particles and may mitigate noise. It can be pressurized or filled with gasses for processing combustible materials. Further, the apparatus can be dismantled for transporting and moving into tight quarters. The use of a housing also facilitates the use of more flights as compared with conventional designs, allowing for higher processing capacity. The apparatus is compact and can be packed relatively tightly compared with conventional spiral separators. Perhaps most importantly, the use of a housing promotes safety by substantially reducing the risk that an operator will be injured by the rotating spiral separator.

### BRIEF DESCRIPTION OF THE DRAWINGS

FIG. 1 illustrates an exploded view of an example spiral separator apparatus according to an embodiment.

FIG. 2 illustrates a plan view of portions of a housing of the spiral separator apparatus of FIG. 1.

FIG. 3 illustrates another plan view of portions of a housing of the spiral separator apparatus of FIG. 1.

FIG. 4 illustrates a plan view of a feed module of the spiral separator apparatus of FIG. 1.

FIG. 5 illustrates a bottom view of the spiral separator apparatus of FIG. 1.

FIG. 6 illustrates a side view of the spiral separator apparatus of FIG. 1.

FIG. 7 illustrates a sectional view of the spiral separator of FIG. 1.

FIG. 8 illustrates a schematic view of a control arrangement of the spiral separator apparatus of FIG. 1.

FIG. 9 illustrates an exploded view of another example spiral separator apparatus according to another embodiment.

FIG. 10 illustrates a side view of the spiral separator apparatus of FIG. 9.

FIG. 11 illustrates a sectional view of the spiral separator of FIG. 9.

FIG. 12 illustrates a schematic view of a control arrangement of the spiral separator apparatus of FIG. 9.

### DETAILED DESCRIPTION

The inventive subject matter is described with specificity to meet statutory requirements. However, the description itself is not intended to limit the scope of this patent. Rather, it is contemplated that the claimed subject matter might also be embodied in other ways, to include different steps or combinations of steps similar to the ones described in this document, in conjunction with other present or future technologies.

According to various disclosed embodiments, a spiral separator apparatus is used to separate a mixture of particles of different shapes. The shape separator apparatus includes rotating separator core that each have a number of banked flights. As the separator cores rotate, non-round particles continue traveling down the banked flights, while round or substantially round particles are ejected from the separator cores by centrifugal force. Particles that are ejected from the separator cores impact a housing, fall, and are collected, for example, in a collection bin.

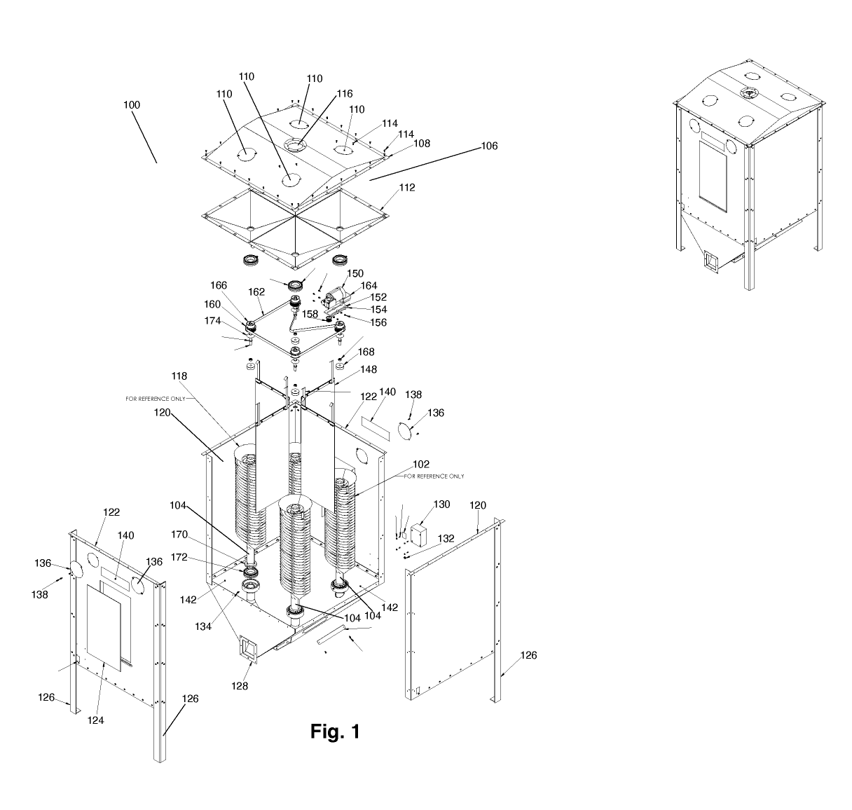

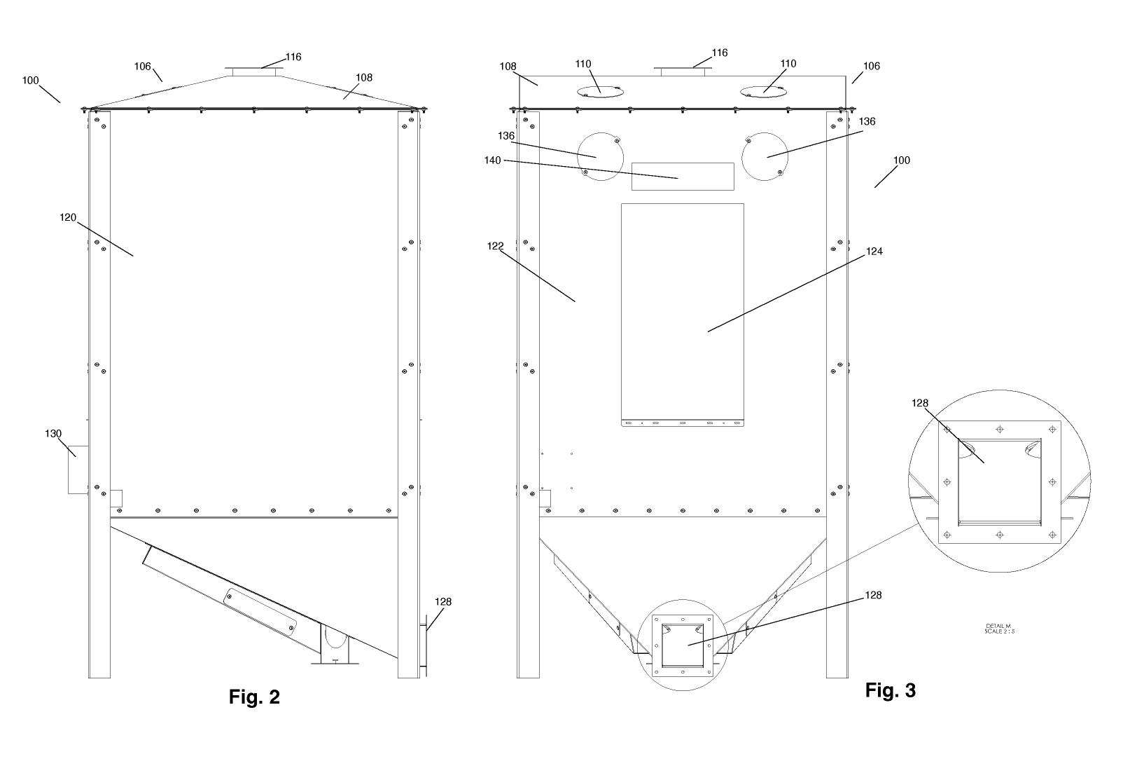

Referring now to the drawings, FIG. 1 illustrates an exploded view of a spiral separator apparatus 100 according to an example embodiment. FIGS. 2-3 show side and top views, respectively, of the spiral separator apparatus 100. Separator cores 102 each having a number of banked flights are spirally wound around respective axes that are coincident with axes of respective hollow bearing shafts 104. The separator cores 102 may be formed from any of a variety of materials suitable for the particular application, such as, for example, steel, galvanized steel, stainless steel, composite, casted material, or a combination of such materials. Unlike some conventional separator cores, the separator cores 102 disclosed herein are modular in that they can be removed from the spiral separator apparatus 100 and exchanged for different separator cores 102, such as separator cores 102 formed from different materials.

In the example embodiment illustrated in FIG. 1, each separator core 102 has eight flights. It will be appreciated by those of ordinary skill in the art that the separator cores 102 may have more or fewer flights. The use of eight flights is advantageous relative to other designs that employ, for example, four flights in that a separator using eight flights can realize approximately 70% greater capacity as compared with a separator using four flights.

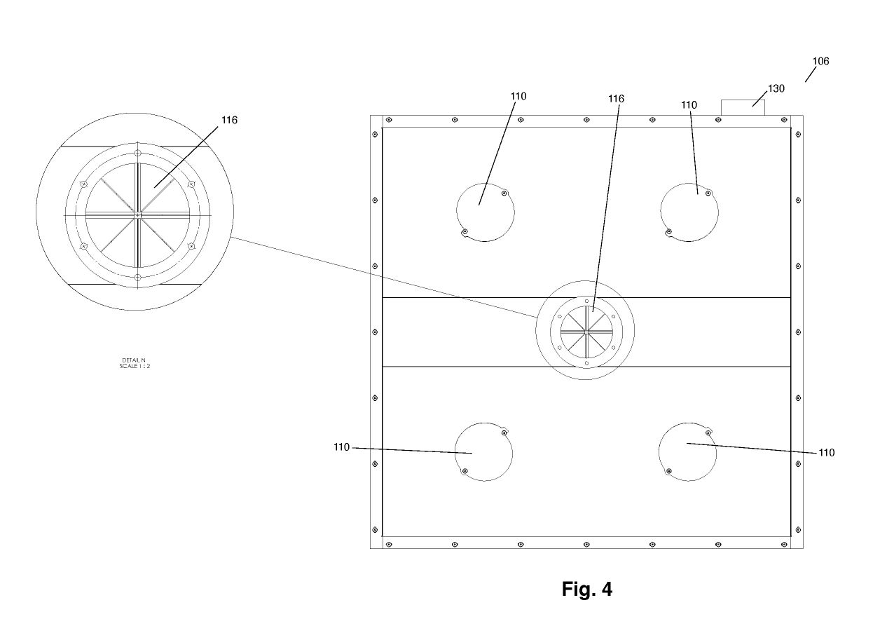

The top portions of the separator cores 102 are located near a feed module 106 of the spiral separator apparatus 100. A top plan view of the feed module 106 is depicted in FIG. 4. The feed module 106 includes a top assembly 108 including access doors 110 and an interior assembly 112 attached to one another, for example, using screws 114. It will be appreciated that the interior assembly 112 has a number of compartments formed therein proximate and around an orifice 116 formed at the top of the top assembly 108, arranged such that material that is introduced into the feed module 106 through the orifice 116 is distributed substantially equally among the compartments. Each compartment feeds the material to a respective separator core 102 through a corresponding orifice formed in the interior assembly 112. In some embodiments, the feed module 106 may be configured to meter or distribute the material substantially evenly among the various flights of each separator core 102. As a particular example, dispersion bowls 118 may be employed to distribute the material substantially evenly among the flights.

Once in the separator cores 102, the material travels down the flights. As the material travels down the banked surface of the flights, its speed increases, and centrifugal force carries the material toward the outer edge of the flights. Spherical or nearly spherical matter travels faster and achieves a velocity sufficient to carry it over the outer edge of the flights. Non-spherical and less dense matter fail to achieve this velocity and do not reach the edge, but rather continue to travel downward and ultimately exit separately at the bottom through the hollow bearing shaft 104.

In contrast to some conventional spiral separators, the separator cores 102 illustrated in FIG. 1 do not have outer flights to catch round particles that are flung off inner flights. Instead, a housing catches the matter that is flung from the flights in this way and discharges it through a discharge chute at the bottom of the housing. The use of a housing allows the outer flight to be omitted, thereby allowing the overall design of the spiral separator apparatus 100 to be more compact relative to conventional designs that use an outer flight. In addition, the housing enhances safety and improves efficiency by reducing or eliminating the number of particles that are flung off the spiral separator apparatus 100 as compared with conventional designs that lack a housing. Noise is reduced. Further, the housing acts as a barrier against ingress or egress of dust or contaminants. The housing also acts as a barrier that prevents the rotating separator core 102 from injuring the operator. In some applications, the housing can be filled or pressurized with specific gasses for processing combustible materials.

The housing is formed by side panel assemblies 120, 122 and is formed from any of a variety of materials suitable for the particular application or environment, such as, for example, steel, galvanized steel, stainless steel, plastic, composite or casted material, or any combination of the above materials. The side panel assembly 122 includes an access door 124 that may be magnetically or otherwise attached to the side panel assembly 122, a leg assembly 126, a lower assembly 128, a motor controller 130, and a grommet 132. The door assembly 124 provides access to the separator cores 102. The lower assembly 128 may be attached to the side panel assemblies 120 and 122 by screws 134, for example. The side panel assemblies 122 include access doors 136 attached to the side panel assemblies 122 by screws 138. Labels 140 may convey warning or other information. The housing may include one or more mats 142 to reduce noise produced when material impacts the bottom of the housing.

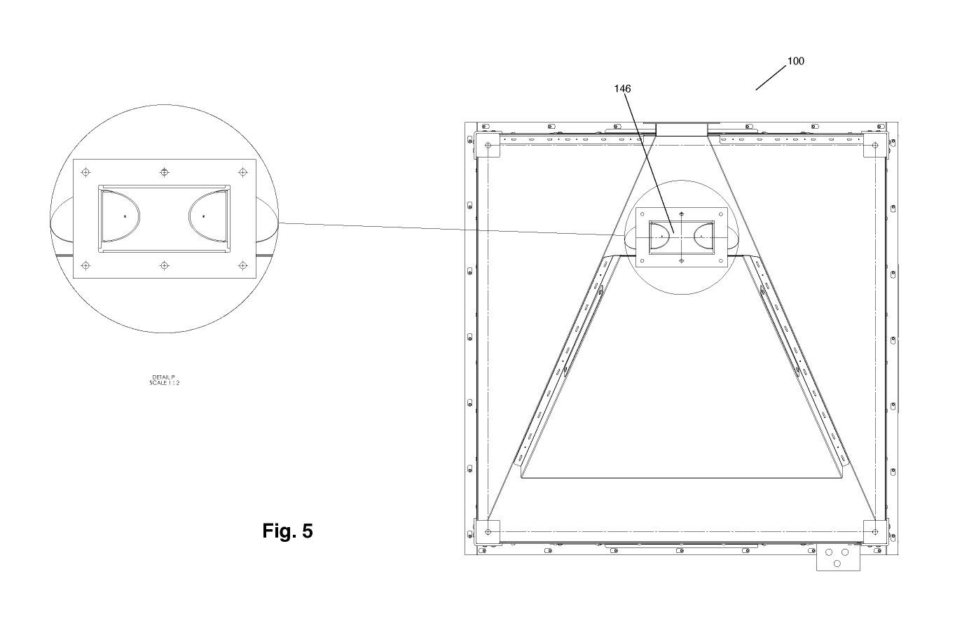

At the bottom of the housing, a discharge chute 144 defined proximate the side panel assembly 122 allows round matter to exit the spiral separator apparatus 100 and to be collected by a first discharge bin (not shown). Non-round matter, on the other hand, travels to the bottoms of the separator cores 102, where it enters the hollow bearing shafts 104 and falls through an orifice 146 formed in the bottom of the spiral separator apparatus 100, as shown in FIG. 5, and is collected, for example, in a second discharge bin (not shown).

In some embodiments, such as the embodiment shown in FIG. 1, the spiral separator apparatus 100 also includes curtain assemblies 148 that separate the separator cores 102 from one another. As a result, material cast from one separator core 102 is prevented from impinging on or entering the flights of another separator core 102.

In contrast to some conventional spiral separators, the spiral separator apparatus 100 disclosed herein is not strictly gravity-fed. In particular, the separator cores 102 are driven by a motor 150 to rotate when the motor is energized. The motor 150 is mounted to the housing of the spiral separator apparatus 100 via a motor mount bracket 152 secured, for example, by a carriage bolt 154 and a lock nut 156. The motor 150 drives a gear 158, which in turn drives gears 160 that are coupled to one another via a belt 162. As the gears 160 are driven, they cause the bearing shafts 104 and, thus, the separator cores 102, to rotate. While FIG. 1 depicts a spiral separator apparatus 100 with a gear and belt drive mechanism, it will be appreciated that other embodiments may use different drive mechanisms, such as a screw drive or a chain drive.

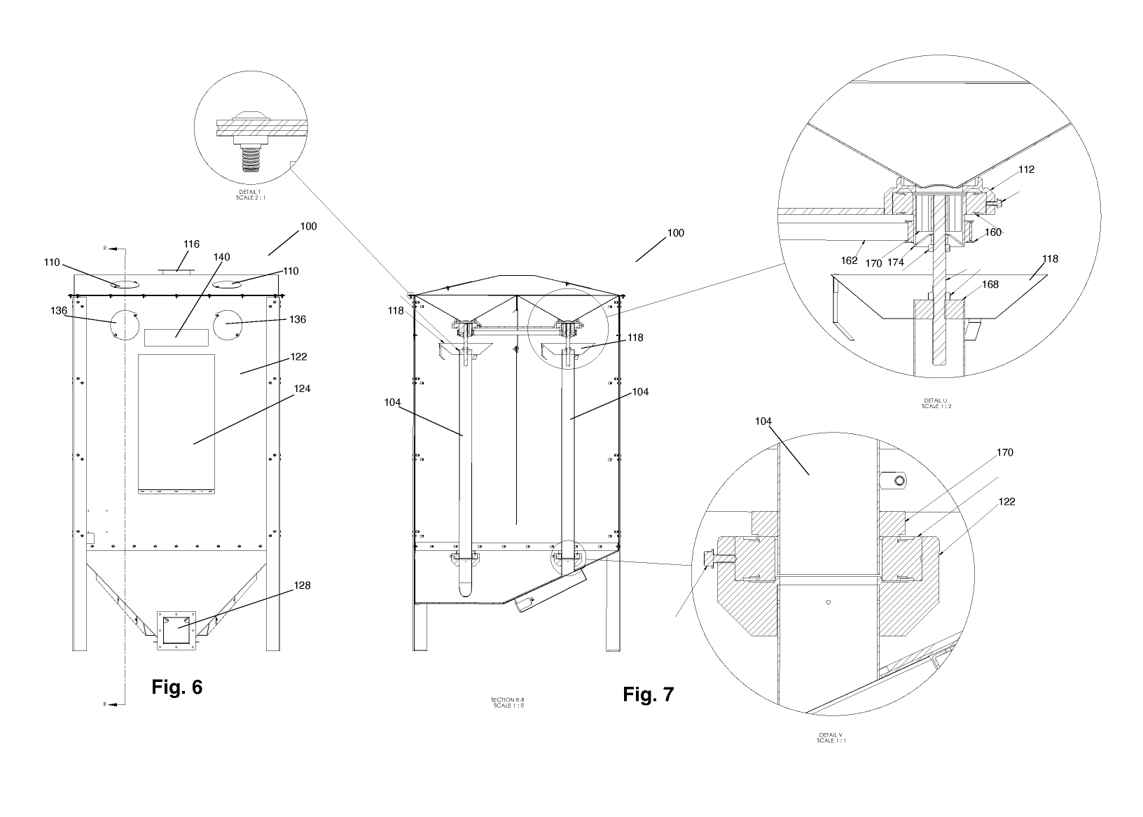

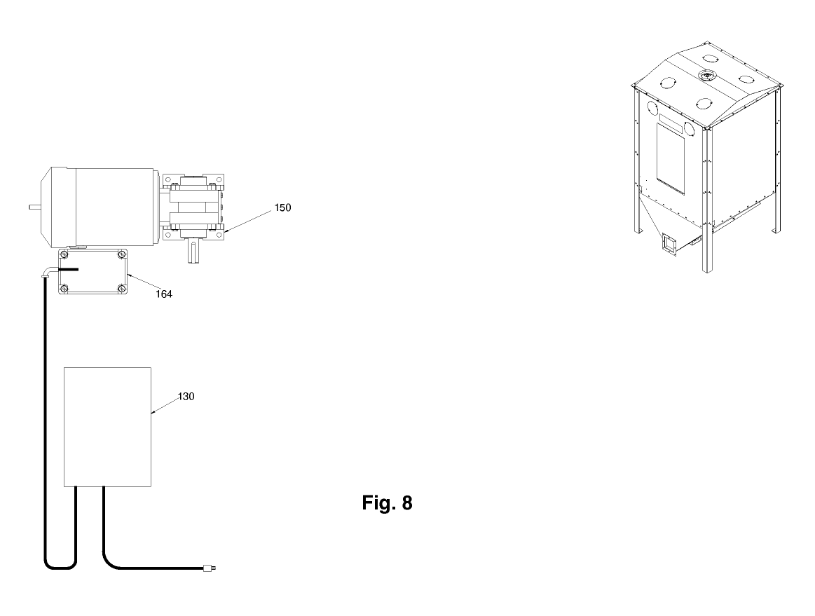

The motor 150 is electrically connected to the motor controller 130 through a terminal box 164. FIG. 7 is a sectional view taken across section line R-R of FIG. 6 and depicts this arrangement. The motor 150 is connected to each bearing shaft 104 via a coupling sleeve 166, a bearing 168, a split shaft collar 170, and a lower bearing 172. Cone plates 174 promote even distribution of material among the flights of each separator core 102.

The rotational speed and direction of the motor 150 and, thus, of the separator cores 102, can be controlled by the motor controller 130. The ability to control the rotational speed and direction of the motor 150 may offer a number of advantages as compared with static spiral separators, which rely on gravity and are not motor-driven. For instance, adjusting the speed and direction of the rotation of the separator core 102 facilitates fine-tuning of the spiral separator apparatus 100 to separate materials of different types, such as metal shot, glass beads, ceramic beads, and metal powders, and sizes. This feature addresses the need in the seed industry to be able to separate varying sizes of the same type of seed, which conventional static separators do not separate well. Further, in the industrial market, e.g., classifying metal shot, glass beads, and ceramic beads by shape, a higher yield of rounds can be achieved relative to static separators. As another benefit, this design can separate fine particle industrial media and powder metals much faster than conventional separators that use a vibrating angled plate.

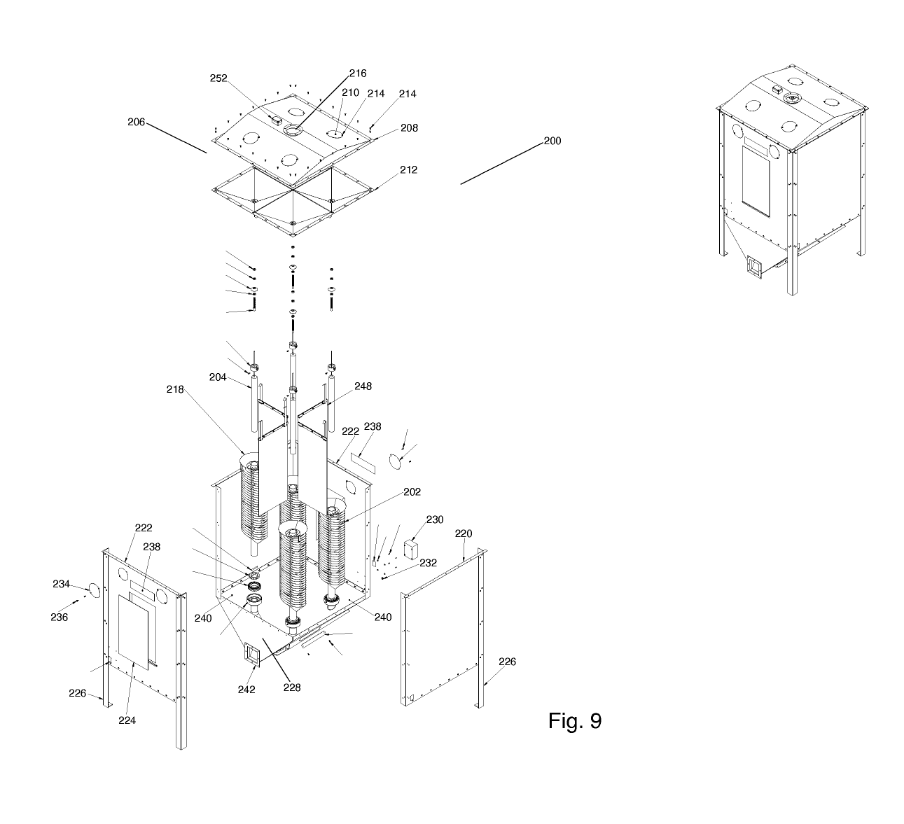

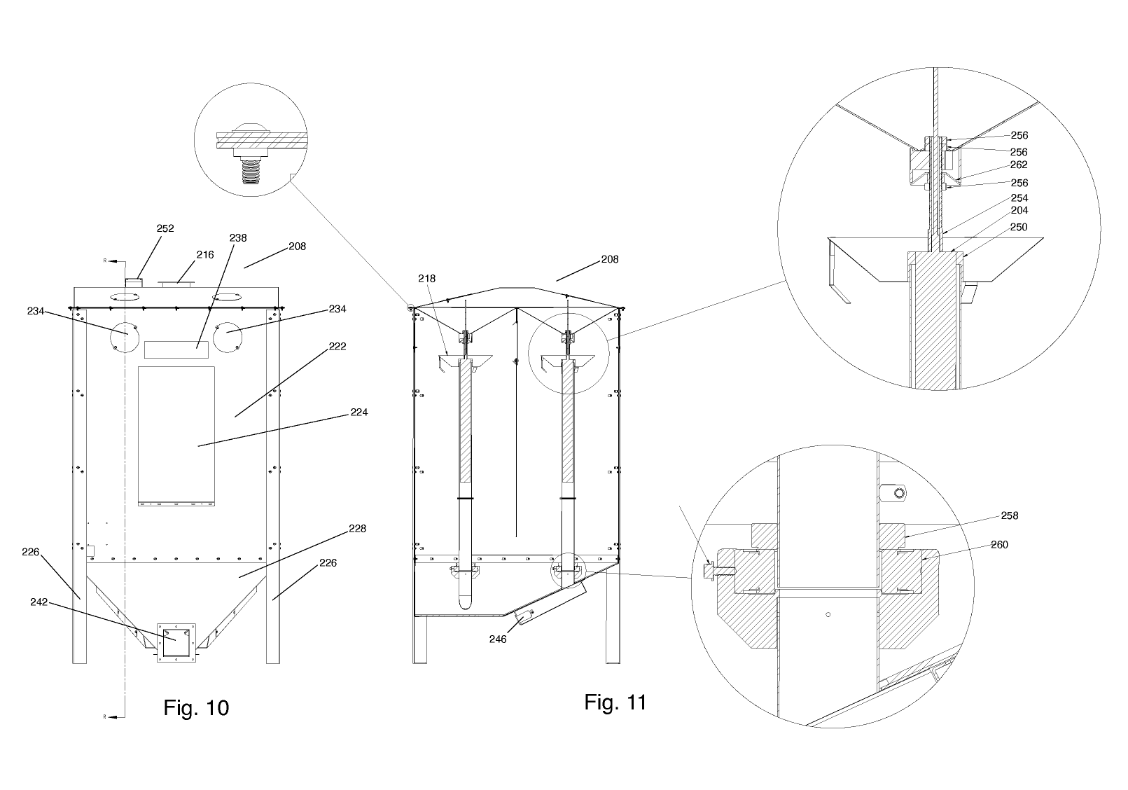

FIG. 9 illustrates an exploded view of a spiral separator apparatus 200 according to another example embodiment. FIGS. 10 and 11 show side and sectional views, respectively, of the spiral separator apparatus 200. Separator cores 202 each having a number of banked flights are spirally wound around respective axes that are coincident with axes of respective motors 204, which are located inside respective hollow bearing shafts. The separator cores 202 may be formed from any of a variety of materials suitable for the particular application, such as, for example, steel, galvanized steel, stainless steel, composite, casted material, or a combination of such materials. Unlike some conventional separator cores, the separator cores 202 disclosed herein are modular in that they can be removed from the spiral separator apparatus 200 and exchanged for different separator cores 202, such as separator cores 202 formed from different materials.

In the example embodiment illustrated in FIG. 9, each separator core 202 has eight flights. It will be appreciated by those of ordinary skill in the art that the separator cores 202 may have more or fewer flights. The top portions of the separator cores 202 are located near a feed module 206 of the spiral separator apparatus 100. The feed module 206 includes a top assembly 208 including access doors 210 and an interior assembly 212 attached to one another, for example, using screws 214. It will be appreciated that the interior assembly 212 has a number of compartments formed therein proximate and around an orifice 216 formed at the top of the top assembly 208, arranged such that material that is introduced into the feed module 206 through the orifice 216 is distributed substantially equally among the compartments. Each compartment feeds the material to a respective separator core 202 through a corresponding orifice formed in the interior assembly 212. In some embodiments, the feed module 206 may be configured to meter or distribute the material substantially evenly among the various flights of each separator core 202. As a particular example, dispersion bowls 218 may be employed to distribute the material substantially evenly among the flights.

Once in the separator cores 202, the material travels down the flights. As the material travels down the banked surface of the flights, its speed increases, and centrifugal force carries the material toward the outer edge of the flights. Spherical or nearly spherical matter travels faster and achieves a velocity sufficient to carry it over the outer edge of the flights. Non-spherical and less dense matter fail to achieve this velocity and do not reach the edge, but rather continue to travel downward and ultimately exit separately at the bottom through the hollow bearing shafts in which the motors 204 are located.

In contrast to some conventional spiral separators, the separator cores 202 illustrated in FIG. 9 do not have outer flights to catch round particles that are flung off inner flights. Instead, a housing catches the matter that is flung from the flights in this way and discharges it through a discharge chute at the bottom of the housing. The use of a housing allows the outer flight to be omitted, thereby allowing the overall design of the spiral separator apparatus 200 to be more compact relative to conventional designs that use an outer flight. In addition, the housing enhances safety and improves efficiency by reducing or eliminating the number of particles that are flung off the spiral separator apparatus 200 as compared with conventional designs that lack a housing. Noise is reduced. Further, the housing acts as a barrier against ingress or egress of dust or contaminants. The housing also acts as a barrier that prevents the rotating separator core 202 from injuring the operator. In some applications, the housing can be filled or pressurized with specific gasses for processing combustible materials.

The housing is formed by side panel assemblies 220, 222 and is formed from any of a variety of materials suitable for the particular application or environment, such as, for example, steel, galvanized steel, stainless steel, plastic, composite or casted material, or any combination of the above materials. The side panel assembly 222 includes an access door 224 that may be magnetically or otherwise attached to the side panel assembly 222, a leg assembly 226, a lower assembly 228, a motor controller 230, and a grommet 232. The door assembly 224 provides access to the separator cores 202. The lower assembly 228 may be attached to the side panel assemblies 220 and 222 by screws, for example. The side panel assemblies 222 include access doors 234 attached to the side panel assemblies 222 by screws 236. Labels 238 may convey warning or other information. The housing may include one or more mats 240 to reduce noise produced when material impacts the bottom of the housing.

At the bottom of the housing, a discharge chute 242 defined proximate the side panel assembly 222 allows round matter to exit the spiral separator apparatus 200 and to be collected by a first discharge bin (not shown). Non-round matter, on the other hand, travels to the bottoms of the separator cores 202, where it enters the hollow bearing shafts in which the motors 204 are located and falls through an orifice 246 formed in the bottom of the spiral separator apparatus 200, as shown in FIG. 11, and is collected, for example, in a second discharge bin (not shown).

In some embodiments, such as the embodiment shown in FIG. 1, the spiral separator apparatus 200 also includes curtain assemblies 248 that separate the separator cores 202 from one another. As a result, material cast from one separator core 202 is prevented from impinging on or entering the flights of another separator core 202.

In contrast to some conventional spiral separators, the spiral separator apparatus 200 disclosed herein is not strictly gravity-fed. In particular, the separator cores 202 are driven by the motors 204 to rotate when the motor is energized. The motors 204 are mounted to respective hollow bearing shafts via respective motor clamps 250 as shown in FIG. 11. The motors 204 directly drive the hollow bearing shafts, and thus the separator cores 202, to rotate.

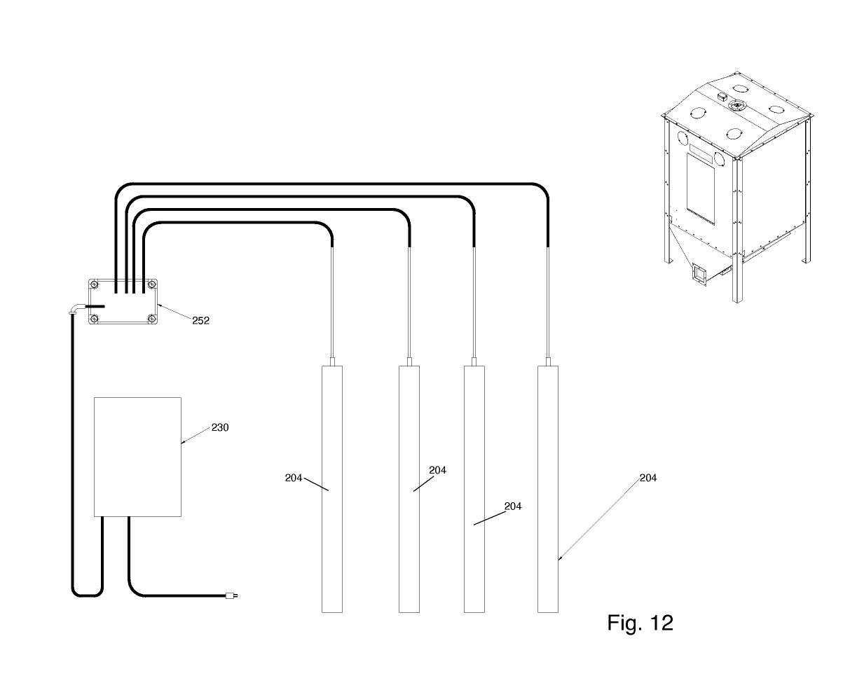

The motors 204 are electrically connected to the motor controller 230 through a terminal box 252, which is shown in FIG. 9 as being mounted to the top assembly 208. FIG. 12 shows this arrangement schematically.

FIG. 11 is a sectional view of the spiral separator apparatus 200 taken across section lines R-R of FIG. 10 that shows additional components of the spiral separator apparatus 200 in greater detail. As shown in FIG. 11, each motor 204 is connected to its respective bearing shaft via the motor clamp 250, a shaft extension 254, nuts 256, a shaft collar 258, and a bearing 260. Cone plates 262 promote even distribution of material among the flights of each separator core 202.

The rotational speed and direction of the motors 204 and, thus, of the separator cores 202, can be controlled by the motor controller 230. The ability to control the rotational speed and direction of the motors 204 may offer a number of advantages as compared with static spiral separators, which rely on gravity and are not motor-driven. For instance, adjusting the speed and direction of the rotation of the separator core 202 facilitates fine-tuning of the spiral separator apparatus 200 to separate materials of different types, such as metal shot, glass beads, ceramic beads, and metal powders, and sizes. This feature addresses the need in the seed industry to be able to separate varying sizes of the same type of seed, which conventional static separators do not separate well. Further, in the industrial market, e.g., classifying metal shot, glass beads, and ceramic beads by shape, a higher yield of rounds can be achieved relative to static separators. As another benefit, this design can separate fine particle industrial media and powder metals much faster than conventional separators that use a vibrating angled plate.

As demonstrated by the foregoing discussion, various embodiments may provide certain advantages. The use of a housing, in particular, may realize a number of benefits. The housing may prevent substantial ingress or egress of contaminants and leakage of round particles and may mitigate noise. It can be pressurized or filled with gasses for processing combustible materials. Further, it is designed to be dismantled for transporting and moving into tight quarters, such as elevators and small openings. The use of a housing also facilitates the use of more flights as compared with conventional designs, allowing for higher processing capacity. It is compact; as a result, it may be possible to pack multiple spiral separator apparatuses more tightly than conventional spiral separators. Perhaps most importantly, the use of a housing promotes safety by substantially reducing the risk that an operator will be injured by the rotating spiral separator.

Using a rotating separator core may also provide certain advantages. The separator core can be rotated at different speeds and different directions to sort different types of materials, such as seed, metal shot, glass particles, and ceramic particles, and electronic components such as resistors. Further, by disengaging the coupling sleeve 190, the operator can remove the separator core for maintenance or for swapping out with another type of separator core, for example, formed from a different material. As a particular example, a steel separator core could be swapped out for a separator core formed from galvanized steel, stainless steel, plastic, composite, or casted material, or a combination of such materials. These features make the spiral separator apparatus 100 disclosed herein more versatile than some conventional designs and suitable for a wide variety of applications.

It will be understood by those who practice the embodiments described herein and those skilled in the art that various modifications and improvements may be made without departing from the spirit and scope of the disclosed embodiments. The scope of protection afforded is to be determined solely by the claims and by the breadth of interpretation allowed by law.

What is claimed is:

1. A spiral separator apparatus comprising:
a motor;
a plurality of hollow shafts coupled to the motor;
a plurality of separator cores, each separator core coupled to a respective one of the plurality of hollow shafts and arranged to rotate when the motor is energized, each separator core comprising a plurality of banked flights spirally disposed around an axis coincident with an axis of the respective hollow shaft;
a feed portion proximate respective top end portions of the separator cores and arranged to receive a mixture of substantially round particles and non-round particles and to distribute the mixture substantially evenly among the separator cores; and
a housing substantially surrounding the separator cores and arranged to be impacted by substantially round particles cast from the separator cores when the separator cores rotate.

2. The spiral separator apparatus of claim 1, further comprising a control module configured to control a rotational speed of the separator cores.

3. The spiral separator apparatus of claim 2, wherein the control module is further configured to control a rotational direction of the separator cores.

4. The spiral separator apparatus of claim 1, further comprising drive means operably connected to the motor and to at least one hollow shaft.

5. The spiral separator apparatus of claim 4, the drive means comprising a belt drive.

6. The spiral separator apparatus of claim 4, wherein the drive means is operably connected to the hollow shafts of the plurality of separator cores via a belt.

7. The spiral separator apparatus of claim 1, wherein the feed portion is arranged to distribute the mixture of substantially round particles and non-round particles substantially evenly among the flights of the separator core.

8. The spiral separator apparatus of claim 7, the feed portion comprising a cone plate.

9. The spiral separator apparatus of claim 1, the feed portion comprising a top assembly and an interior assembly connected to form a plurality of compartments disposed about an orifice formed in the top assembly.

10. A spiral separator apparatus comprising:
a motor;
a control module configured to control a rotational speed of the motor;
a plurality of hollow shafts;
a belt drive coupled between the motor and the hollow shafts and arranged to rotate the hollow shafts when the motor is energized;
a plurality of separator cores, each separator core coupled to a respective hollow shaft and arranged to rotate when the respective hollow shaft rotates, each separator core comprising a plurality of banked flights spirally disposed around an axis coincident with an axis of the respective hollow shaft; and
a feed portion proximate a top end portion of the separator core and arranged to receive a mixture of substantially round particles and non-round particles and to distribute the mixture substantially evenly among the plurality of separator cores.

11. The spiral separator apparatus of claim 10, further comprising a housing substantially surrounding the separator cores and arranged to be impacted by substantially round particles cast from the separator cores when the separator cores rotate.

12. The spiral separator apparatus of claim 10, further comprising a curtain assembly inside the housing and separating the separator cores from one another.

13. The spiral separator apparatus of claim 10, wherein the control module is further configured to control a rotational direction of the separator core.

14. The spiral separator apparatus of claim 10, wherein the feed portion is arranged to distribute the mixture of substantially round particles and non-round particles substantially evenly among the flights of the separator core.

15. The spiral separator apparatus of claim 10, the feed portion comprising a cone plate.

16. A method of separating a plurality of substantially round particles from a mixture of the substantially round particles and a plurality of non-round particles, the method comprising steps of:
energizing a motor to cause a plurality of separator cores of a spiral separator apparatus to rotate about respective axes, each separator core comprising a plurality of banked flights spirally disposed around a respective hollow shaft;
passing the mixture of substantially round particles and non-round particles through a feed portion of the separator apparatus;
distributing the mixture of substantially round particles and non-round particles among the separator cores, the substantially round particles being ejected from the banked flights of the separator cores and impacting a housing substantially surrounding the separator cores when the separator cores rotate; and
collecting the substantially round particles after the substantially round particles impact the housing.

17. The method of claim 16, further comprising controlling a rotational speed of the motor.

18. The method of claim 16, further comprising controlling a rotational direction of the motor.

19. The method of claim 16, wherein the feed portion is arranged to distribute the mixture of substantially round particles and non-round particles substantially evenly among the flights of the separator cores.

20. The method of claim 16, wherein the motor, when energized, drives a belt drive that causes the separator cores to rotate.
